(19) United States
(12) Patent Application Publication
(10) Pub. No.: US 2026/0111732 A1
(43) Pub. Date: Apr. 23, 2026

(54) METHODS AND PROCESSING ELEMENTS FOR COMPRESSING AND DECOMPRESSING NEURAL NETWORK WEIGHTS

(71) Applicant: Arm Limited, Cambridge (GB)

(72) Inventors: Dibakar GOPE, Austin, TX (US); David Hennah MANSELL, Norwich (GB); Danny Daysang LOH, Menlo Park, CA (US); Ian Rudolf BRATT, Portola Valley, CA (US)

(21) Appl. No.: 18/944,925

(22) Filed: Nov. 12, 2024

Related U.S. Application Data
(60) Provisional application No. 63/709,189, filed on Oct. 18, 2024.

(51) Int. Cl. G06N 3/082; G06N 3/0495

(52) U.S. Cl. CPC G06N 3/082; G06N 3/0495

(57) ABSTRACT

Methods and apparatus for compressing and decompressing weight values associated with neural networks. Input weight values are divided into groups, with each group being processed using a scale factor. For each group of scaled input weight values, a codebook is identified from multiple codebooks, where each codebook represents a discrete set of centroid values. Input weight values within each group are encoded using centroid values from the identified codebook, resulting in encoded weight values comprising codebook indices and centroid indices. During decompression, the encoded weight values are processed to reconstruct output weight values using the corresponding codebooks and scale factors. The codebooks are generated by identifying similar distributions of scaled input weight values across different groups and clustering these values to determine centroid values. A processing element performs the decompression operations to reconstruct the weight values for use in neural network operations.

### CROSS-REFERENCE TO RELATED APPLICATIONS

This application claims the benefit of U.S. Provisional Application No. 63/709,189, filed Oct. 18, 2024 under 35 U.S.C. § 119(a). The above-referenced patent application is incorporated by reference in its entirety.

### BACKGROUND OF THE INVENTION

### Field of the Invention

The present disclosure relates to data compression and decompression techniques, particularly to methods and systems for compressing and decompressing weight values associated with neural networks. More specifically, the disclosure relates to quantization techniques for neural network weight values using codebooks and centroid values.

### Description of the Related Technology

Neural networks process data through interconnected nodes characterized by parameters that define relationships between nodes. These parameters form the basis for neural network computations and determine how input data propagates through the network layers. Modern neural network architectures can contain millions of parameters, which necessitates substantial memory resources for storage during both training and inference operations. The quantity of parameters tends to scale with the depth and width of neural network architectures.

The storage and transmission of neural network parameters present technical challenges in practical applications. As neural networks grow in size and complexity, the associated memory requirements increase proportionally. Data transfer bandwidth limitations can affect the deployment of neural networks across different computing platforms and environments. Processing large sets of parameters demands computational resources during both the training phase, when parameters are updated iteratively, and the inference phase, when parameters are used to generate predictions or outputs from input data.

Various techniques can be applied to reduce the memory and bandwidth requirements associated with neural network parameters. Traditional data compression methods may not adequately preserve the numerical precision needed for neural network computations. Implementation of data reduction schemes involves consideration of efficiency ratios and computational overhead. The processed parameter data requires restoration operations to recover values for use in neural network calculations, which introduces additional processing steps in the computation pipeline.

Parameter reduction approaches provide methods for reducing neural network memory usage by representing parameters with modified numerical precision. These techniques involve transforming floating-point parameter values to alternative representations that can be stored with fewer bits. Various implementations utilize different mechanisms to enable mapping between original parameter values and their modified representations. Mathematical operations can be incorporated into parameter processing to maintain numerical relationships while reducing the memory footprint of the neural network.

### SUMMARY

In accordance with examples, a method processes a set of input weight values associated with a neural network to produce encoded weight values. The input weight values are organized into multiple groups. For each group, a scale factor is applied to the weight values. A codebook is identified from multiple available codebooks, where each codebook represents a discrete set of centroid values. The method processes each scaled input weight value within a group by selecting a centroid value from the identified codebook's discrete set of centroid values to represent that scaled input weight value.

For each group, the method encodes a codebook index that represents the identified codebook from among the available codebooks. The method also encodes centroid indices that represent the centroid values chosen to represent the input weight values in that group. The output comprises encoded weight values that include, for each group, a codebook index and corresponding centroid indices for the input weight values in that group.

Different groups of input weight values may be processed using different scale factors and codebooks. For example, a first group may use a first scale factor and first codebook, while a second group may use a second scale factor and second codebook. The method may apply different scale factors across groups while selecting codebooks from the same set of available codebooks. The number of available codebooks may range from four to sixteen codebooks, and in some cases may consist of exactly four codebooks. The number of input weight values in each group may correspond to an integer multiple of a width of a Single Instruction Multiple Data (SIMD) vector.

The codebook indices used to represent the identified codebooks may be encoded using 2 bits. The centroid indices that represent the selected centroid values can be encoded using either 2 bits or 3 bits, and in some implementations specifically use 2-bit encoding. The number of codebooks may be selected such that all codebooks can fit within a local register file of a processor.

The input weight values may be derived from weight matrices of large language models (LLM).

The input weight values may be FP16 (16-bit floating-point) or FP32 (16-bit floating-point), with a scale factor being used to reduce the bit-width of the centroid values. The centroid values may be signed 8-bit integers. For example, if the required bit-width of centroid values in a codebook is a signed 8-bit integer, the scale factor for a group scales the group's weights to the −128 to 127 range.

The codebooks used in the compression method may contain centroids that are distributed non-uniformly across their value ranges.

A decompression method processes encoded weight values to reconstruct output weight values associated with a neural network. The encoded weight values are organized into multiple groups. For each group of encoded weight values, the method obtains a codebook index and multiple centroid indices. The codebook index is used to identify a specific codebook from multiple available codebooks, where each codebook represents a discrete set of centroid values. Using the identified codebook and the centroid indices, the method identifies centroid values for the group of encoded weight values. A scale factor is then applied to these values.

The decompression method produces output weight values that correspond to the encoded weight values. For each group, the output comprises weight values that correspond to the identified centroid values after applying the respective scale factor for that group.

The decompression process may handle different groups using different parameters. For example, a first group may use a first codebook (identified by a first codebook index) and first scale factor to process its centroid indices, while a second group may use a second codebook and second scale factor. The method may apply different scale factors across groups while selecting codebooks from the same set of available codebooks. The number of available codebooks may range from four to sixteen codebooks. The number of input weight values in each group may correspond to an integer multiple of a width of a Single Instruction Multiple Data (SIMD) vector.

The set of codebooks used in the decompression method may consist of exactly four codebooks. The codebook indices used to identify specific codebooks may be encoded using 2 bits. The centroid indices that specify particular centroid values from the identified codebooks can be encoded using either 2 bits or 3 bits, and in some implementations specifically use 2-bit encoding. The number of codebooks may be selected such that all codebooks can fit within a local register file of a processor.

The weight values processed through the decompression method may be derived from weight matrices of large language models (LLM). The codebooks used in the decompression process may contain centroids that are distributed non-uniformly across their value ranges.

A method for generating codebooks for quantizing weight values processes input weight values associated with one or more neural networks. The method applies a group-wise structure to organize the input weight values and applies scale factors to the respective groups to generate scaled input weight values. For each codebook being generated, the method identifies similar distributions of scaled input weight values across different groups. The scaled input weight values from these similar distributions are clustered into discrete clusters to identify a predetermined number of centroid values, which are then used to generate a codebook.

A processing element can be configured to perform decompression of encoded weight values. The processing element obtains encoded weight values organized in groups, processes codebook indices and centroid indices for each group, identifies appropriate codebooks and centroid values, applies scale factors, and outputs reconstructed weight values.

A computing device can implement these methods using storage, at least one processor, and a network interface for receiving data such as input data and weight data. The device includes a user interface for interaction and command input. The components are interconnected via a system bus for data transfer between components. The storage contains computer program instructions that, when executed by the processor, implement the compression, decompression, or codebook generation methods.

### BRIEF DESCRIPTION OF THE DRAWINGS

Examples of the present disclosure will now be described with reference to the accompanying drawings:

FIG. 1 is an exploded view showing a three-dimensional weight tensor;

FIG. 2 is a schematic diagram showing internal components of a computing device;

FIG. 3A is a schematic diagram showing a user interface of a computing device;

FIG. 3B is a diagram showing hardware of the mobile device;

FIG. 4 is a flowchart showing a method for compressing weight values in neural networks;

FIG. 5 is a flowchart showing a method for group-wise quantization of weight values;

FIG. 6 is a flowchart showing a method for processing groups of input weight values according to an example;

FIG. 7 is a flowchart showing a method for processing groups of input weight values according to a further example;

FIG. 8 is a flowchart showing a method for decompressing encoded weight values; and FIG. 9 is a flowchart showing a method for generating multiple codebooks for quantizing weight values.

### DETAILED DESCRIPTION OF CERTAIN INVENTIVE EMBODIMENTS

Generative Large Language Models (LLMs) have demonstrated remarkable results for a wide range of tasks. A language model can predict the next word given a context or a question. LLMs are trained with massive amounts of data to learn language patterns. They can perform tasks ranging from summarizing and translating texts to responding in chatbot conversations. As a result, facilitating their efficient execution on CPUs will expand their reach to billions of devices. LLMs are often memory-bandwidth and memory capacity-bound, with memory accesses dominated by weights, allowing CPUs the opportunity to achieve competitive performance and outperform other processors and accelerators in terms of overall inference/cost. Furthermore, CPUs are pervasive, providing portability and flexibility, so a new LLM compression scheme can work seamlessly on CPUs without much effort.

Examples provide for the operation of LLMs on CPUs deployed in datacenters, smartphones, and edge devices. Deploying these LLMs for inference has been a significant challenge due to their unprecedented size and resource requirements. One of the primary performance bottlenecks in LLM inference for generative tasks is memory bandwidth. Quantization is an effective approach to converting high-precision (16 or 32-bit) model weights to lower-precision values without significantly affecting accuracy. It lowers the model's memory and computational requirements, making it better suited for deployment on devices with limited resources.

While 8-bit quantization reduces LLM storage requirements (from 16-bit precision) by half, the largescale size of LLMs suggests quantizing them to even lower precisions (for example, 4, or even lower bit widths). Expensive decoding schemes and large model footprint access of existing quantization methods have a significant impact on runtime performance. This motivates the development of faster inference kernels as well as runtime-friendly, fast, and accurate quantization methods. Existing quantization methods do not perform well and result in notable degradation quality at very high compression ratios, such as 2-bit quantization.

Examples described herein provide a novel non-uniform codebook-based post-training quantization method that enables ultra-low-precision quantization of LLMs while outperforming the state-of-the-art in terms of text generation quality and runtime performance. This can be accomplished through applying non-uniform codebook-based quantization over group-wise structured LLM weight matrices, in conjunction with identifying and using a reduced number of codebooks, preferably as few as possible within the requirements, to capture the various non-uniform weight distributions for all LLM layers. Preferably, the codebooks for all of them can be stored in an CPU's register file (for example, a single 128-bit vector register). This, combined with CPU-optimized codebook-based group-wise quantized matrix multiply kernels, can result in significantly improved runtime performance for models in the domain of LLM. It should be noted that whilst CPU-based generative inference is described, the techniques described herein are general and should be extensible to other settings as well.

Examples provide a group-wise codebook-based quantization method for ultra-low-precision quantization of LLMs to better match non-uniform patterns in their weight distributions, allowing large-scale LLMs to fit on smaller devices and demonstrating better throughput during token generation while ensuring better quality than the state-of-the-art. Examples provide a pareto-optimal solution in terms of model quality and runtime performance for 2-bit quantization and outperform the state-of-the-art 2-bit quantization techniques in terms of LLM quality while requiring fewer bits per weight and no additional training or finetuning.

### Weight Tensor Structure

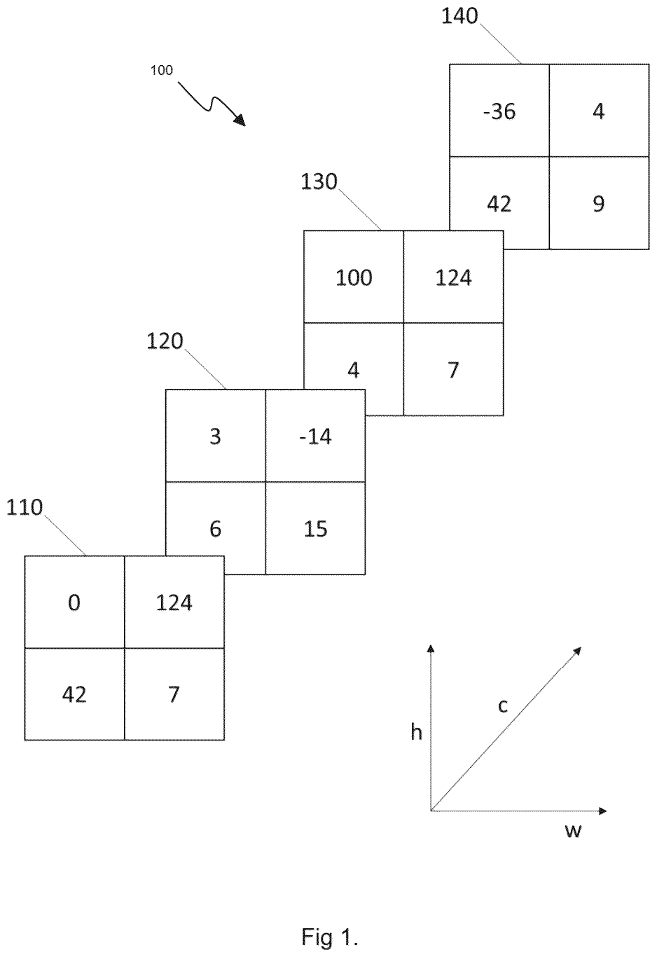

To motivate the techniques described herein, FIG. 1 shows an example exploded view of a 2×2×4 three-dimensional weight tensor 100. A three-dimensional weight tensor 100 can be defined using three dimensions: height (h), width (w), and channel (c), which are comparable to x, y, and z dimensions respectively. These dimensions are marked in the bottom right of the figure. While three-dimensional weight tensors 100 are shown here for clarity, tensors may also be implemented in two or four dimensions comprising two or more stacked three-dimensional kernels.

FIG. 1 illustrates four 2×2 tensors, respectively labelled 110, 120, 130, 140. Each 2×2 tensor comprises 4 weight values. Collectively, the four 2×2 tensors 110 to 140 form 2×2×4 three-dimensional weight tensor 100, which comprises 16 weight values. Each weight value is represented as a numerical value. Weight values can be stored in various data formats based on model requirements, hardware capabilities, and trade-offs between precision, memory, and computation. High-precision weight values commonly use 32-Bit Floating Point (float32) or 16-Bit Floating Point (float16) formats. However, these high-precision formats require substantial memory resources, for example, float32 values require 4 bytes per weight value while float16values require 2 bytes per weight value.

Due to the massive size of certain neural networks, such as LLMs, post-training quantization (PTQ) may be used for acceleration during inference and running them efficiently. By reducing the precision of pre-trained LLMs, PTQ methods save memory and speed up LLM inference while preserving most of the model quality at scale when compared to the performance and compute requirements of other compression techniques such as pruning and quantization-aware training (QAT). While aggressive weight quantization is used for LLMs to reduce inference costs, activation quantization may be less of an issue due to their smaller memory footprint, so activations may be quantized to a higher bit width, for example to 8 bits, than the weights.

Examples use group-wise PTQ offering improved kernels for group-quantized LLMs, demonstrating significantly improved performance for a variety of low-bit widths on CPUs.

Instead of uniform quantization techniques, post-training non-uniform quantization techniques are used in examples in order to better match the non-uniform patterns commonly found in LLM weight distributions. The high overhead of accessing codebooks, combined with the complex decompression path can result in poor runtime performance. However, in examples, group-wise codebook-based quantization provides not only faster throughput but also better quality under very high compression scenarios (e.g., 2-bit quantization).

LLMs are made of transformer layers. Given an input prompt, each round through this LLM network generates a new token, and the new token is fed into the LLM for generating the token in the next round. For the next round, the LLM may need the initial prompt and the answer generated so far as the input context to generate the next token. However, since all the tokens except the last generated token remain the same as the previous round, in order to save on redundant computation, the LLM stores the embeddings for them in KV caches when they are generated for the first time. So in the next round, the LLM simply retrieves the history, state, or embeddings of the previous tokens and processes the last generated token in conjunction with the previous embeddings to generate the next token. The LLM updates the history with the last token and repeats the process until a complete answer is generated.

For typical operators in LLMs, weight matrices are significantly larger than activation matrices. As a result, compression of the weight matrix is critical to reducing memory and bandwidth consumption, so in examples they are quantized to 4 or fewer bits. Group-wise quantization has a finer granularity than standard tensor-wise or channel-wise quantization, allowing it to reduce quantization noise natively while approaching the full-precision (floating point) quality of a foundation model. Group-wise quantization quantizes in groups, whereby weights are divided into groups of 32, 64, or 256. Each group is then quantized individually to mitigate the effect of outliers and increase precision. This weight quantization is chosen to optimize space and bandwidth, as well as to make the decompression process easier during inference, whereas the activation quantization format is chosen to facilitate subsequent integer dot product computation with group-quantized weights.

Uniform quantization divides the range of weight values into equal intervals and assigns a quantization level to each interval. It distributes quantized values uniformly and equidistantly. As a result, despite being commonly used in conjunction with group-wise quantization for LLMs, it is not very flexible in matching the non-uniform patterns typically found in LLM weight distributions resulting in suboptimal accuracy, especially for low-precision LLM quantization.

Non-uniform quantization adjusts the quantization intervals based on the probability distribution of the input signal, with smaller intervals in regions of higher probability, resulting in lower average distortion and quantization noise. Given a weight distribution, non-uniform codebook-based quantization can identify k centroids that best represent the weight values and map weights to them. For example, when quantizing a weight distribution to 4-bits, state-of-the-art codebook-based quantization techniques aim to determine the 16 centroid values that best represent the values. Each high-precision weight can then be represented by the 4-bit index of a centroid in the codebook instead of its original bit width. In addition, non-uniform codebook-based quantization requires storing the codebook itself and incurring associative overhead.

Examples described herein address limitations in prior non-uniform quantization techniques and attempts to fill the void by not only ensuring faster throughput but also better quality under very high compression scenarios (e.g., 2-bit quantization) for LLMs.

### Computing Device Components

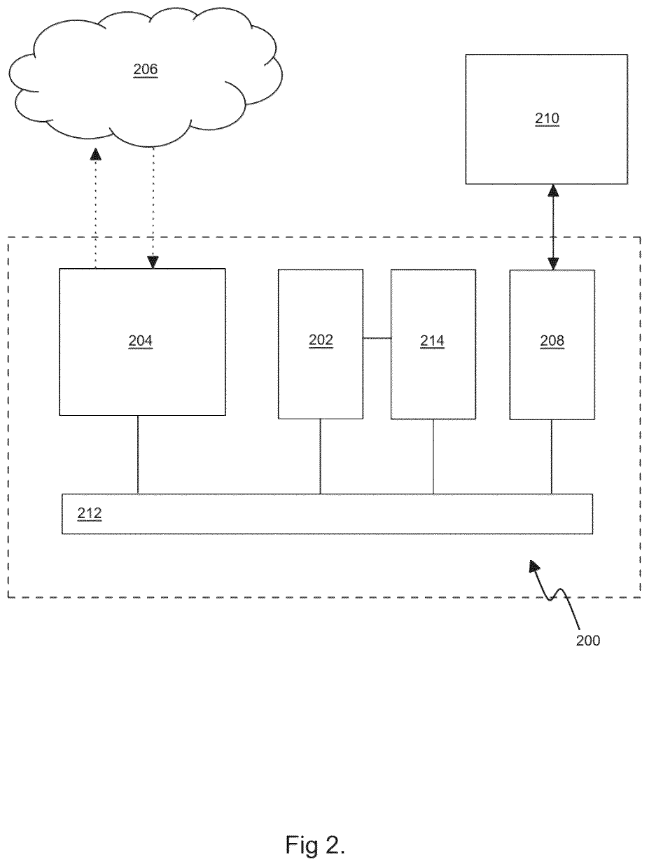

The methods described herein may be implemented on any suitable computing device. FIG. 2 is a schematic diagram showing internal components of a computing device 200 for use with the methods described herein. The computing device 200 includes storage 202, a network interface 204, a network 206, an interface 208, a user interface 210, a system bus 212, and a processing element 214.

The storage 202 may include one or more volatile memory, such as Random Access Memory (RAM) and non-volatile memory, such as Read Only Memory (ROM) or a solid state drive (SSD) such as Flash memory. The storage 202 may include magnetic or optical storage devices or other storage media. The storage 202 can be removable, such as SD or USB type drives, or non-removable from the computing device 200. The storage 202 can store data elements including input data, weight bits, and output data. The storage 202 includes computer program instructions that, when processed by the processing element 214, implement methods for processing data. The computer program instructions and data may be stored in an accessible non-transitory computer-readable medium and loaded into memory.

The network interface 204 can be communicatively connected to a network 206 to receive data, such as input data and weight data. The network interface 204 may connect to, and receive data via, any known wired or wireless data transfer technology. The network 206 may be the Internet, a local Intranet, a local or remote data server, or a link to another local or remote computing device.

The interface 208 and user interface 210 are configured to, in conjunction, provide a user with the ability to interact with the computing device 200 to input commands, data, and/or other information. The computing device 200 can accumulate data from the network 206 into a dataset in the storage 202.

The processing element 214 is communicatively coupled to the storage 202 and may be used to implement neural networks. These processing element types include neural processing units (NPUs) and other custom processors specifically adapted for neural network computations, as well as more generalized processors adapted to perform neural network computations, including neural network capable central processing units (CPUs), graphical processing units (GPUs), digital signal processors (DSPs), etc. Generally, these types of processors may have “on-chip” data storage, for example in the form of one or more static random-access memory (SRAM) units, dynamic random-access memory (DRAM) units, a data buffer or any other type of memory.

The processing element 214 may also include a microprocessor, a general-purpose processor, an application specific integrated circuit (ASIC), a digital signal processor (DSP), a field programmable gate array (FPGA) or other programmable logic device, discrete hardware components, discrete gate or transistor logic, or any suitable combination thereof capable of performing decompression functions. The processing element 214 may also be implemented as a combination of computing devices, such as a plurality of processors, a combination of a DSP and a microprocessor, one or more microprocessors in conjunction with a DSP core, or other configuration.

The components of the computing device 200 are interconnected using a system bus 212, allowing data to be transferred between the various components of the computing device 200.

### Computing Device Overview

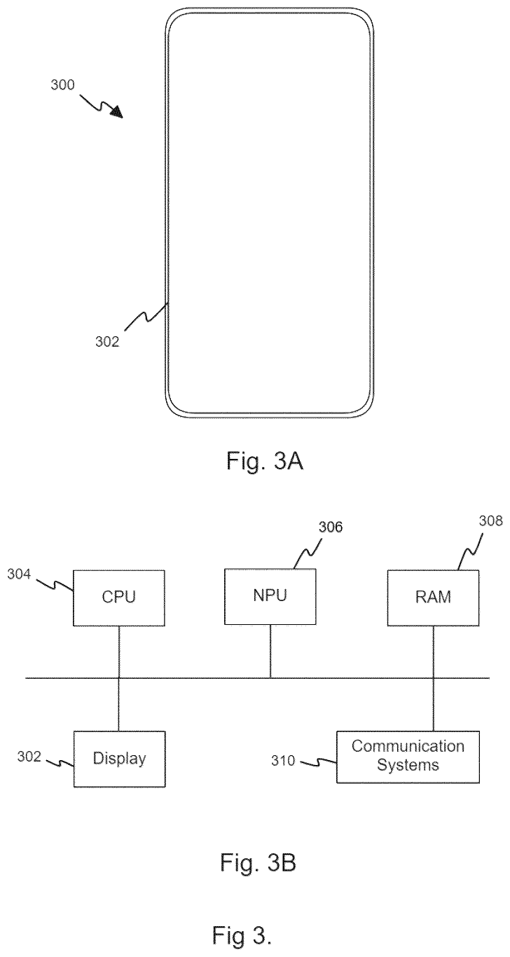

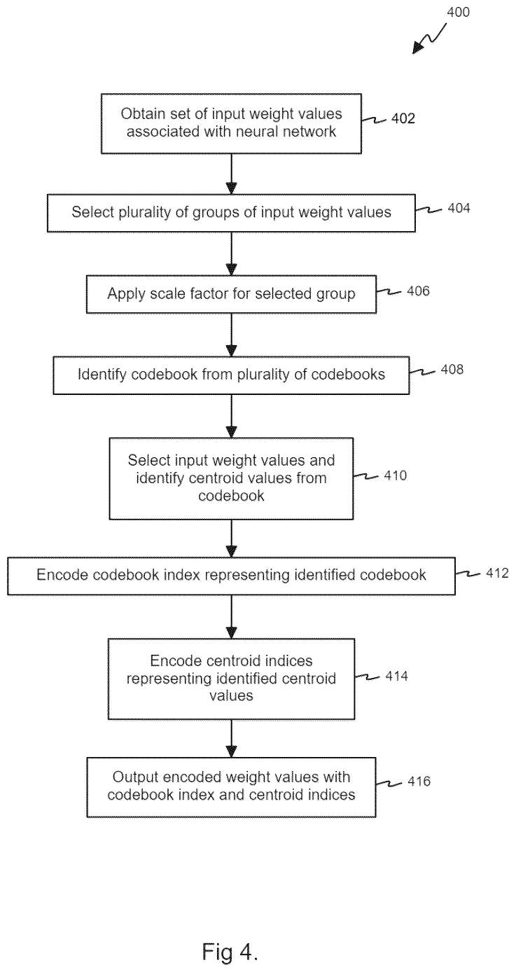

FIG. 3A shows an example computing device in the form of a mobile device 300. As describe above, ultra-low-precision quantization of neural networks as described herein allows large-scale LLMs to fit on smaller devices, such as the mobile device 300. Although described in relation to a mobile device, the techniques can be applied to any type of computing device that retrieves weight values associated with neural networks including tablet computers, laptop computers, personal computers (PC), servers, and other computing devices.

The mobile device 300 includes a user interface 302 for displaying information to a user. The user interface 302 can include a touchscreen display, physical buttons, keyboards, trackpads, or other input/output mechanisms commonly found on mobile devices. The user interface 302 allows users to interact with applications, view content, and control device functions.

FIG. 3B is a diagram showing hardware of the mobile device. A processing element 304 in the form of a CPU handles general computing tasks. The computing device 300 also includes a neural processing unit (NPU) 306, which functions as a specialized processor for performing calculations relating to artificial intelligence, particularly calculations relating to neural networks. The NPU 306 can efficiently process matrix multiplications, convolutions, and other operations commonly used in neural network inference and training. The NPU 306 includes dedicated hardware optimized for parallel processing of neural network operations.

Random access memory (RAM) 308 provides storage for the computing device 300. While not illustrated, additional non-volatile storage is also provided. The RAM 308 stores program instructions, data, neural network parameters, and other information needed during operation of the computing device 300.

Communication systems 310 enable the computing device 300 to connect to and transfer data over various data networks. These communication systems 310 can utilize technologies such as Wi-Fi™ and cellular networks. Additional data network technologies that can be supported include Bluetooth, NFC, Ethernet, and other wired or wireless communication protocols.

The components of the computing device 300 are interconnected via a system bus that facilitates data transfer between the various components. This allows the processing element 304 and NPU 306 to access data stored in RAM 308, receive input from the user interface 302, and communicate through the communication systems 310.

### Group-wise Codebook-based Quantization Methods

For LLM weight matrices, which are commonly quantized group-wise, there may be some variations in the shape of the gaussian distribution of values between groups. However, after being scaled by the group-wise scale factors, the gaussian distributions of various groups with different shapes should be clustered into a small set of shapes, each of which can be represented with its own codebook.

In examples described herein, a group-wise structure is applied to divide the high bit-width floating point weights into groups and scale each group separately first, using its own scale factor. The scale factor is chosen so that the ranges of values after scaling can be represented by codebook's bit width. For example, if the required bit width of centroid values in a codebook is a signed 8-bit integer, the scale factor for a group scales the group's weights to the −128 to 127 range. A clustering algorithm (e.g. constraint-satisfaction-guided clustering algorithm) may then be used to cluster the scaled group of weight values into a small number of codebooks, each with the same discrete number of centroid values, which may be a small number, for example four or eight. The clustering of similar groups into the same codebook aids a group in locating the closest codebook that best represents its values, while the small number of centroid values for each codebook ensures that high-precision centroid values, such as four 8-bit signed centroids in a codebook, can be encoded using a lower bit-width index (2-bit indices here) in the codebook.

For very high compression cases, quantization bit width and associated number of distinct values or quantization bins (e.g., 16 distinct values for 4-bit quantization) have the greatest impact on LLM accuracy. Changes in the bit-precision of scale factors, on the other hand, have less of an impact on LLM accuracy. The various codebooks in group-wise codebook-based quantization essentially help in adapting a group to choose a subset of relatively higher-precision data type while using low bit-width indices (4 most important quantization bins of 16 for a group here using 2-bit indices). This can result in closely following the distribution of quantization bins of a higher-precision data type and bridging the accuracy gap with it.

Furthermore, examples of codebook-based quantization keep the decompression path in converting low-bit codebook indices to high-precision centroid values relatively simple, resulting in improved throughput.

### Group-wise Codebook-based 2-bit Quantization (Q2_NL)

Examples described herein apply a codebook-based quantization technique to compress LLMs to slightly more than 2 bits per weight. In examples, a 2-bit codebook-based quantization scheme has four codebooks. They are found by first applying a group-wise structure and scale factors to LLM weight matrices and then dividing and placing similar groups (groups with similar distributions) into four clusters. The four clustered groups are then processed by using a clustering algorithm individually to cluster values in them into four codebooks, each with four centroids. Later, during post-training quantization of a group-wise structured LLM, the various groups of weight values choose one of the four codebooks that is deemed to best match their distribution according to a cost function, for example with the lowest reconstruction MSE (mean square error). In examples, each group of weight values requires two bits to encode the selected codebook's index, as well as two bits for each of its elements to encode one of the codebook's four centroids.

In examples, a 2-bit codebook-based quantization technique has four codebooks, and each codebook may have four centroids, for example, four signed 8-bit integer centroids. In examples, a group size of 16 with 2-bit quantized elements and its own scale factor may be used. Each group also has a 2-bit codebook index, which may be used to index into one of the four codebooks and extract centroid values corresponding to the 2-bit quantized index elements. In examples, an FP16 (16-bit floating-point) scale factor may be used for the 16-wide group.

Note that the codebook-based quantization scheme can be extended for other bit widths, such as 3-and 4-bit quantization. This may for example be achieved by dividing similar groups into a small number of clusters (for example, one or two) and then encoding each clustered group with an 8- (for 3-bit index) or 16-entry (for 4-bit index) codebook.

### Algorithm 1

### Q2_NL Non-uniform Codebook-based Quantization:

Input: High-precision model weights W, divided into groups of size g
Step 1: Scale each group of high-precision weights to the −128 to 127 range by using FP16 scale factors.
Step 2: Cluster the similar weight groups created in Step 1 (groups of scaled weight values with similar gaussian distributions) into C clusters by performing the following steps:
   Convert each group of scaled weight values to a probability distribution. One method is to scale each group of values to a smaller range (for example, [−m, m] range, where m=8), then find the histogram of the scaled values and normalize it, converting the discrete distribution of intensities into a discrete distribution of probabilities.
   Apply clustering analysis (for example, k-means clustering) to these probability distributions, which now represent the different groups, to cluster the similar groups.
Step 3: Apply clustering analysis now to each clustered group of values (created in Step 2) to identify a few centroid values that best represent the probability distribution of weight values within each. Repeat Step 3 for C clustered groups of values to create C codebooks to find the different non-uniform weight distributions present in the high-precision weights W.
Step 4: Use C codebooks created in Step 3 to perform post-training quantization of high-precision input weight values by performing the following steps:
   group of scaled input weight values←group of high-precision input weight values/FP16 scale factor
   codebook index, centroid indices for a group←For a group of scaled input weight values, choose a codebook (of the C codebooks) that best matches their distribution with the lowest reconstruction MSE (mean square error), and map weights to the centroid values in the chosen codebook. Output encoded data representative of the selected codebook and mapped centroid values.
Repeat for each group of high-precision input weight values.
   Output: C codebooks, FP16 scale factor, codebook index, and corresponding centroid indices for each group of high-precision input weight values.

### Algorithm 2

### Q2_NL Decompression and Inference

Input: C codebooks, FP16 scale factor, codebook index, and corresponding centroid indices for each group of quantized weight values from Algorithm 1
For each group of quantized weight values:
   centroid values←codebooks [codebook index][centroid indices]
   decompressed values←FP16scale facto*centroid values
      Output: Decompressed model weights W, divided into groups of size g

### Weight Compression Method

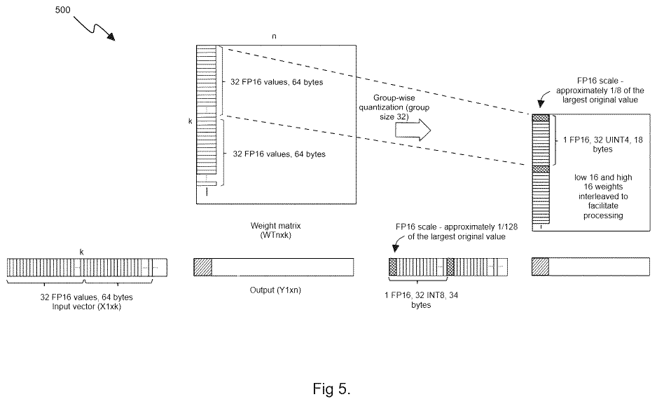

FIG. 4 illustrates a general method 400 for compressing a set of input weight values to produce a set of encoded weight values according to an example. The method 400 can be performed by any suitable computing device, such as the computing devices shown in FIGS. 2 and 3.

At block 402, a set of input weight values associated with a neural network is obtained. The neural network may be of any type, including a large language model (LLM), convolutional neural network (CNN), recurrent neural network (RNN), or transformer network. The input weight values may comprise high-precision weight values.

At block 404, a plurality of groups of input weight values are selected from the set of input weight values. A minimum number of input weight values in a group may be dictated by a Single Instruction Multiple Data (SIMD) vector width. This may allow the resultant matrix multiply kernels to benefit from vectorization and take advantage of efficient vectorized integer computation and matrix multiple operations. Each group may comprise an integer multiple of 16 input weight values, such as 16, 32, 64, or 128 values.

At block 406, a scale factor is applied for a selected group. The scale factor may be chosen such that the ranges of values after scaling can be represented by a codebook's bit width. For example, if the required bit width of centroid values in a codebook is a signed 8-bit integer, the scale factor for a group scales the group's input weight values to the −128 to 127 range. As previously mentioned, for certain neural network weight matrices, such as those of LLMs, which are commonly quantized group-wise, there may be some variations in the shape of the gaussian distribution of values between groups. However, it has been observed that after being scaled by the group-wise scale factors, the gaussian distributions of various groups with different shapes can be clustered into a small set of shapes, each of which can be represented with its own codebook.

At block 408, a codebook is identified from a plurality of codebooks. A clustering algorithm, such as a constraint-satisfaction-guided clustering algorithm, may be used to cluster the scaled group of weight values into a small number of codebooks. A codebook represents a discrete set of centroid values that can be used to represent the scaled input weight values. The codebooks may have non-uniformly distributed centroids. In some examples, each centroid may be a signed 8-bit integer. A codebook may be selected from the plurality of codebooks that is found to best match a distribution for the current group based on a cost function, such as the lowest reconstruction MSE (mean square error). The plurality of codebooks may be generated using the method shown in FIG. 9.

At block 410, for each of a plurality of scaled input weight values in the selected group, an input weight value is selected, and a centroid value is identified from the discrete set of centroid values represented by the identified codebook. The clustering of similar groups into the same codebook aids a group in locating the closest codebook that best represents its scaled input weight values. The small number of centroid values for each codebook ensures that high-or medium-precision centroid values, such as four 8-bit signed centroids in a codebook, can be encoded using a lower bit-width index, such as 2-bit indices. The centroid values may have more than 8 bits. In some examples, 8-bit signed centroid values may be used so that 8-bit integer arithmetic may be performed on the centroid values At block 412, a codebook index representing the identified codebook is encoded. The codebook index is one of a plurality of codebook indices representing the codebooks. The codebook indices may comprise 2-bit codebook indices, allowing for 4 codebooks. Additional examples include 3-bit codebook indices for 8 codebooks or 4-bit codebook indices for 16 codebooks. Particular utility is to be found in applications using either 2-bit codebook indices or 3-bit codebook indices.

At block 414, centroid indices representing the identified centroid values are encoded. Each centroid may be indexed, where the centroid indices may comprise 2-bit, 3-bit or 4-bit centroid indices. The size of the centroid indices is related to the number of centroids in a codebook.

At block 416, a set of encoded weight values corresponding to the set of input weight values is output. The set of encoded weight values comprises, for each of the plurality of groups of input weight values, a codebook index for the group and a plurality of centroid indices corresponding to the plurality of input weight values in the group.

The encoding of weight values using codebook and centroid indices reduces the storage requirements compared to storing full precision weights. The codebook indices and centroid indices can represent weight values using fewer bits than the original weight values. This compact representation allows neural networks to be stored and deployed with lower memory overhead. This allows large-scale neural networks to fit on smaller devices.

The combination of scale factors with multiple codebooks provides adaptability to different weight distributions across groups while maintaining compression efficiency. Multiple codebooks enable different groups of weights to be encoded using codebook distributions that match their characteristics.

### Group-wise Weight Quantization Process

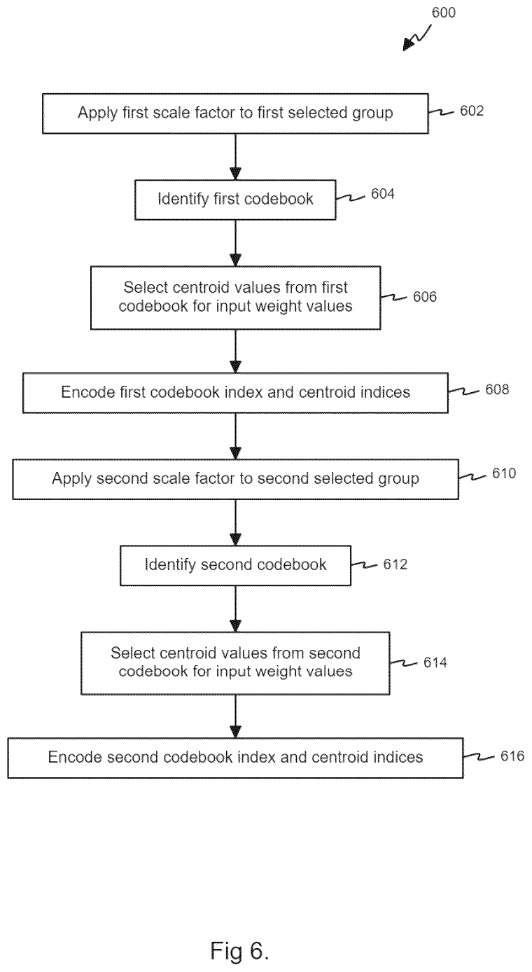

FIG. 5 illustrates additional aspects of the method of weight compression described in FIG. 4. The method 500 shows a group-wise quantization process.

In this example, weight values are divided into groups, where each group contains V elements and has an associated scale factor. A group size V of 32 is used, though other group sizes can be selected (as described above). For each group of 32 floating-point weights, the values are quantized into 4-bit integer values (4-bit centroid indices for codebook based quantization) using a local scale factor specific to that group. For non-uniform codebook-based quantization, each group also has a codebook index field (not shown in this figure) to index into one of the codebooks.

The process continues sequentially through the weight tensor, with each subsequent set of 32 consecutive weights being quantized to 4-bits using a different scale factor calculated for that particular group. This group-wise approach continues until the entire weight tensor has been processed. The scale factors are stored using FP16 (16-bit floating-point) precision to maintain adequate numerical precision while keeping storage requirements low.

### Multiple Group Weight Processing Method

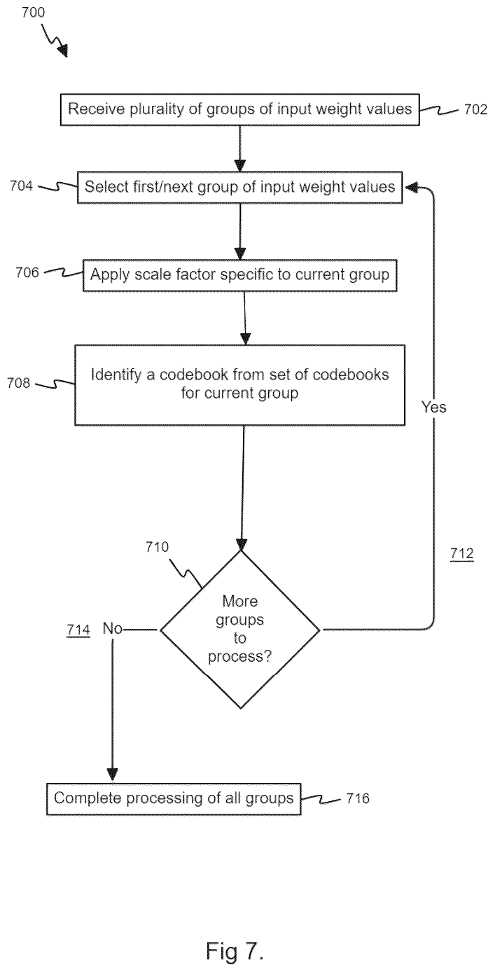

FIG. 6 illustrates a method 600 that provides additional detail for processing multiple groups of input weight values according to the method shown in FIG. 4. The blocks 602-608 and 610-616 may be performed in a manner similar to blocks 406-412 as described with respect to FIG. 4.

For a first selected group of input weight values, at block 602, a first scale factor is applied to the first selected group. At block 604, a first codebook is identified from the plurality of codebooks, based on the distribution of the scaled input weight values. At block 606, for each of the plurality of input weight values in the first selected group, an input weight value is selected, and a centroid value is identified from the discrete set of centroid values represented by the first codebook to represent the selected input weight value. At block 608, a first codebook index representing the first codebook is encoded, along with first centroid indices representing the centroid values identified to represent the plurality of input weight values in the first selected group.

For a second selected group of input weight values, at block 610, a second scale factor is applied to the second selected group. At block 612, a second codebook is identified from the plurality of codebooks. At block 614, for each of the plurality of input weight values in the second selected group, an input weight value is selected and a centroid value is identified from the discrete set of centroid values represented by the second codebook to represent the selected input weight value. At block 616, a second codebook index representing the second codebook is encoded, along with second centroid indices representing the centroid values identified to represent the plurality of input weight values in the second selected group.

The processing of multiple groups allows different scale factors and codebooks to be applied to different portions of the input weight values. This enables the compression technique to adapt to variations in weight distributions across different parts of a neural network. Each group can be processed with a scale factor and codebook that are appropriate for the characteristics of the weight values within that particular group.

Processing different groups of input weight values independently with separate scale factors and codebooks provides flexibility in compression. The weight distributions can vary significantly between different portions of a neural network. Using group-specific parameters allows the compression to better match the statistical properties of each group's weight values.

### Group-wise Codebook Selection Process

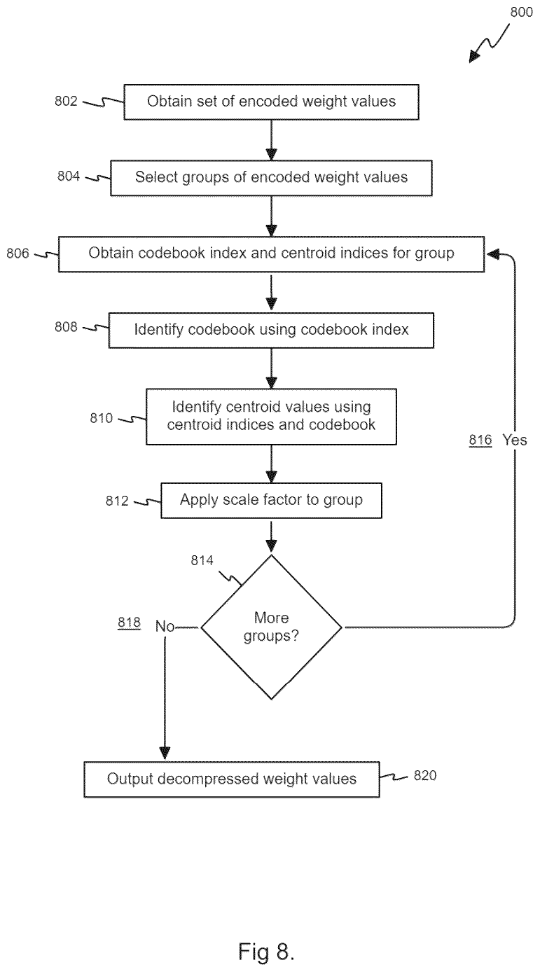

FIG. 7 illustrates a method 700 that provides additional detail for processing multiple groups of input weight values according to the methods shown in FIGS. 4 and 6, where a codebook from a set of codebooks is identified for each of the plurality of groups after applying different scale factors to each group. As mentioned, there may be some variations in the shape of the gaussian distribution of values between groups. However, after being scaled by the group-wise scale factors, the gaussian distributions of various groups with different shapes can be clustered into a small set of shapes, each of which can be represented with its own codebook.

At block 702, a plurality of groups of input weight values are received. At block 704, a first or next group of input weight values is selected for processing. At block 706, a scale factor specific to the current group is applied. The scale factor may be chosen to map the weight values in the current group to an appropriate range for codebook representation.

At block 708, a codebook is identified from the set of codebooks for the current group. A codebook is selected from the set of codebooks that is found to best match their distribution for the current group based on a cost function, such as the lowest reconstruction MSE (mean square error). The identified codebook represents a discrete set of centroid values that can be used to represent the input weight values in the current group. Different groups of input weight values may be encoded using different codebooks, or the same codebook. The same codebook can be used for a plurality of scaled groups of values that fit its distribution. The selection of a codebook across different groups allows for consistent encoding while the group-specific scale factors enable adaptation to different weight value distributions.

At decision block 710, a check is performed to determine if there are more groups to process. If the condition 712 indicates there are additional groups (Yes), the method returns to block 704 to select and process the next group. If the condition 714 indicates there are no more groups to process (No), the method proceeds to block 716 where processing of all groups is completed.

The steps 702-708 may be performed in a manner similar to steps 402-408 as described with respect to FIG. 4. The iterative processing of groups with different scale factors and identification of a codebook from the set enables efficient compression while maintaining adaptability to variations in weight distributions across different portions of a neural network.

The use of a common codebook across different groups while applying distinct scale factors provides a streamlined implementation approach. Memory requirements are reduced since the codebook can be stored once and referenced by multiple groups. The processing overhead is minimized by reusing the established codebook structures rather than maintaining separate codebooks for each group.

### Weight Decompression Method

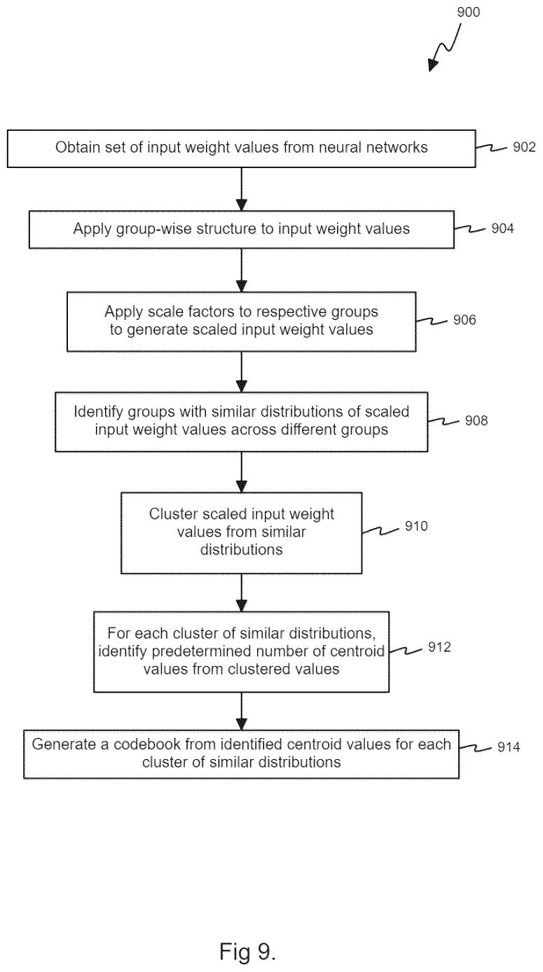

FIG. 8 illustrates a decompression method 800 that complements the compression method shown in FIG. 4. The method 800 decompresses a set of output weight values from a set of encoded weight values, where the set of output weight values may have been previously compressed using the method of FIG. 4.

At block 802, a set of encoded weight values corresponding to a set of output weight values is obtained. The set of output weight values includes weight values associated with a neural network, which may be of any type including large language models, convolutional neural networks, recurrent neural networks, or transformer networks.

At block 804, a plurality of groups of encoded weight values corresponding to a plurality of groups of output weight values are selected from the set of encoded weight values. The groups may be sized according to Single Instruction Multiple Data (SIMD) vector widths, such as multiples of 16 for 128-bit vector registers divided into 16 8-bit lanes.

At block 806, for a selected group of encoded weight values, a codebook index and a plurality of centroid indices are obtained from the selected group of encoded weight values.

At block 808, one of a plurality of codebooks is identified using the obtained codebook index. Each codebook represents a discrete set of centroid values. The codebooks may contain non-uniformly distributed centroids, where each centroid may be a signed 8-bit integer.

At block 810, a plurality of centroid values for the selected group of encoded weight values is identified from the plurality of centroid indices using the identified codebook. The centroid values are derived from the discrete set of centroid values represented by the identified codebook. A table lookup of a codebook register may be performed to obtain the codebook and centroid values. For example, with a 128-bit vector register comprising 16 8-bit lanes, each group of weights may be associated with a corresponding codebook ID (or codebook index). A codebook index for a group of size 16 may be replicated across all 16 lanes in the vector register, shifted by a specified amount to create space, and combined with per-lane centroid IDs using an OR operation to generate a table lookup vector for the codebook register.

At block 812, a scale factor is applied to the selected group. The scale factor maps the centroid values back to their original range of values.

At decision block 814, the method determines if there are more groups to process. If yes 816, the method returns to block 806 to process the next group. If no 818, the method proceeds to block 820.

At block 820, the set of output weight values corresponding to the set of encoded weight values is output. The set of output weight values comprises weight values corresponding to the identified centroid values for each group, scaled by the respective scale factor for that group.

The structured approach to decompressing weight values enables rapid reconstruction of the original neural network weights. By utilizing codebooks and centroid indices, the decompression process can be performed through efficient lookup operations. The organization of weight values into groups allows parallel processing of multiple values simultaneously.

The hierarchical encoding structure reduces memory requirements during storage and transmission of neural network weights. Codebooks store a compact set of representative centroid values while indices reference these values. The combination of codebooks and indices provides an efficient representation that maintains the ability to accurately reconstruct the original weight values.

The application of scale factors on a per-group basis supports precise reconstruction of weight magnitudes. Different regions of a neural network may contain weights spanning different numerical ranges. The use of multiple codebooks in conjunction with group-specific scaling allows each set of weights to be mapped back to appropriate values for their respective network regions.

### Multiple Codebook Generation Method

FIG. 9 illustrates a method 1100 for generating multiple codebooks that can be used in the compression and decompression techniques described in relation to FIGS. 4, 6, 7, and 8. The codebooks generated using this method for a first neural network may be used for a second neural network having the same architecture, allowing a single set of codebooks to be generated for a given class of neural networks.

At block 902, a set of input weight values associated with one or more neural networks is obtained. These weight values may come from any type of neural network, including large language models, convolutional neural networks, recurrent neural networks, or transformer networks.

At block 904, a group-wise structure is applied to the set of input weight values. This structure organizes the weight values into multiple groups, where each group may contain weight values from different parts of the neural network. The groups may be sized according to requirements such as Single Instruction Multiple Data (SIMD) vector widths.

At block 906, scale factors are applied to respective groups of the group-wise structure to generate scaled input weight values for each group. The scale factors map the weight values in each group to ranges suitable for codebook representation while preserving relative weight magnitudes within groups.

At block 908, similar distributions of the scaled input weight values are identified across different groups in the group-wise structure. This identification process examines statistical properties and patterns in the scaled weight values to find groups that share comparable value distributions.

At block 910, scaled input weight values from the identified similar distributions of different groups are clustered into discrete clusters. The input weight values from similar distribution may be clustered into a small, predetermined number of clusters. The clustering process groups together scaled weight values that exhibit similar characteristics, allowing common representation patterns to be identified.

At block 912, for each cluster of scaled input weight values, a predetermined number of centroid values are identified. These centroid values serve as representative values that can efficiently encode the weight values in the current selected cluster. The number of centroid values may be chosen based on factors such as desired compression ratio and accuracy requirements.

At block 914, a codebook is generated from the identified centroid values. The codebook contains the discrete set of centroid values that can represent the input weight values in the current selected cluster. This process repeats for every cluster of scaled weight values for each codebook to be generated, creating multiple codebooks that can capture different patterns and distributions present in the neural network weights.

The generated codebooks provide a compact representation scheme that can be used across multiple neural networks with similar architectures. By identifying and leveraging a small number of weight value distributions across different groups, the codebooks enable efficient compression while maintaining the ability to accurately represent the original weight values.

The generation of codebooks through identification of similar distributions across different groups enables shared representation of weight patterns. This approach reduces redundancy by allowing weight values with comparable statistical properties to be encoded using common centroid values. The resulting codebooks provide compact yet representative encoding that maintains the characteristics of the original weight distributions.

The application of scale factors to individual groups preserves the relative relationships between weight values while facilitating effective compression. Scale factors map weight values to ranges suitable for codebook representation without losing important magnitude information. This group-specific scaling approach accommodates varying weight distributions across different parts of the neural network.

The clustering of weight values based on distribution similarity produces well-suited centroid values for compression. By considering the statistical patterns across groups, the clustering process identifies representative values that capture common characteristics. This distribution-aware approach results in codebooks that effectively represent weight values across multiple groups.

### Additional Variations

In some examples, the set of codebooks may include between four and sixteen codebooks. A specific implementation may utilize exactly four codebooks. The codebook indices may be implemented as 2-bit indices, allowing for efficient storage and processing of the codebook selections.

The centroid indices may be implemented as either 2-bit or 3-bit indices, with 2-bit centroid indices being used in certain examples. This selection of bit width for centroid indices enables a balance between compression efficiency and representation accuracy.

The codebooks may be implemented with non-uniformly distributed centroids. This non-uniform distribution can be advantageous for capturing the statistical properties of the weight values being compressed, potentially leading to improved compression quality compared to uniformly distributed centroids.

These variations may be combined in various ways. For example, a system might use four codebooks with 2-bit codebook indices and 2-bit centroid indices to compress input weights from LLM weight matrices, while utilizing non-uniformly distributed centroids in the codebooks.

The use of between four and sixteen codebooks allows for effective data compression while maintaining representation accuracy. This range provides sufficient flexibility to capture meaningful patterns in the data. The number of codebooks can be selected within this range based on specific requirements for compression ratio and precision needs. The use of between four and sixteen codebooks allows for practical implementation while maintaining reconstruction quality. This range provides sufficient granularity for encoding weight values without requiring excessive computational resources. The upper limit helps control memory usage and processing overhead while the lower limit ensures adequate representation capability. Restricting a number of codebooks to a small number of values to fit them into a processor's local register file may allow efficient vector lookup, for example table lookup instructions, can be used to access multiple centroid values from them at the same time.

The use of four codebooks can provide a practical balance between data compression and reconstruction quality. The four-codebook configuration allows for efficient implementation while maintaining suitable compression ratios. This approach helps manage computational resource requirements during both compression and decompression operations.

The use of 2-bit codebook indices provides a compact representation for weight value storage. This format enables efficient compression of the weight data while retaining sufficient precision for practical applications. The 2-bit structure for centroid indices in a codebook allows for four distinct index values, supporting effective mapping between weight values and their corresponding codebook entries. The use of 2-bit codebook indices allows for compact representation of codebook selections. Each index requires only two bits of storage space, enabling efficient memory utilization during compression and decompression operations. This approach supports high compression ratios while retaining sufficient precision to accurately identify and select the appropriate codebook for weight quantization.

The use of either 2-bit or 3-bit centroid indices allows for flexibility in precision selection. A 2-bit implementation can prioritize memory efficiency and processing speed, while a 3-bit implementation can provide enhanced representation accuracy. This adaptability enables systems to be configured based on specific model requirements and available computational resources. The use of both 2-bit and 3-bit centroid indices provides flexibility in implementation. A 2-bit representation allows for higher compression ratios while a 3-bit representation enables greater reconstruction accuracy. This adaptable precision allows the compression scheme to be tailored based on specific application requirements and resource constraints.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

What is claimed is:

1. A method of compressing a set of input weight values to produce a set of encoded weight values, the method comprising:
obtaining a set of input weight values, the set of input weight values including a plurality of weight values associated with a neural network;
selecting a plurality of groups of input weight values from the set of input weight values;
for a selected group in the plurality of groups of input weight values:
applying a scale factor for the selected group to produce scaled input weight values from input weight values in the group;
identifying one of a plurality of codebooks, each of the codebooks representing a discrete set of centroid values;
for each of a plurality of scaled input weight values in the selected group, selecting the scaled input weight value and identifying a centroid value, from the discrete set of centroid values represented by the identified codebook, to represent the selected scaled input weight value;
encoding a codebook index representing the identified codebook, the codebook index being one of a plurality of codebook indices representing the codebooks in the plurality of codebooks; and
encoding a plurality of centroid indices representing the centroid values identified to represent the plurality of scaled input weight values; and
outputting a set of encoded weight values corresponding to the set of input weight values, the set of encoded weight values comprising, for each of the plurality of groups of input weight values, data representative of a said encoded codebook index for the group and data representative of a said plurality of centroid indices corresponding to the plurality of input weight values in the group.

2. A method according to claim 1, wherein the method comprises:
for a first selected group in the plurality of groups of input weight values:
applying a first scale factor for the first selected group to produce scaled input weight values from input weight values in the first selected group;
identifying a first codebook of the plurality of codebooks;
for each of a plurality of scaled input weight values in the first selected group, selecting the scaled input weight value and identifying a centroid value, from the discrete set of centroid values represented by the first codebook, to represent the selected scaled input weight value;
encoding a first codebook index representing the first codebook; and
encoding a first plurality of centroid indices representing the centroid values identified to represent the plurality of scaled input weight values in the first selected group; and
for a second selected group in the plurality of groups of input weight values:
applying a second scale factor for the second selected group to produce scaled weight values from input weight values in the second selected group;
identifying a second codebook of the plurality of codebooks;
for each of a plurality of scaled input weight values in the second selected group, selecting the scaled input weight value and identifying a centroid value, from the discrete set of centroid values represented by the second codebook, to represent the selected scaled input weight value;
encoding a second codebook index representing the second codebook; and
encoding a second plurality of centroid indices representing the centroid values identified to represent the plurality of scaled input weight values in the second selected group.

3. A method according to claim 1, wherein the method comprises applying a different scale factor and identifying a codebook from a same set of codebooks for each of the plurality of groups of input weight values.

4. A method according to claim 3, wherein the set of codebooks consists of between four and sixteen codebooks.

5. A method according to claim 1, wherein a number of input weight values in each group is equal to an integer multiple of a width of a Single Instruction Multiple Data (SIMD) vector.

6. A method according to claim 1, wherein the codebook indices comprise 2-bit codebook indices.

7. A method according to claim 1, wherein the centroid indices comprise 2-bit or 3-bit centroid indices.

8. A method according to claim 1, wherein a number of the plurality of codebooks is such that the plurality of codebooks fit into a local register file of a processor.

9. A method according to claim 1, wherein the codebooks comprise codebooks having non-uniformly distributed centroids.

10. A method of decompressing a set of output weight values from a set of encoded weight values, the method comprising:
obtaining a set of encoded weight values corresponding to a set of output weight values, the set of output weight values including a plurality of weight values associated with a neural network;
selecting a plurality of groups of encoded weight values corresponding to a plurality of groups of output weight values from the set of output weight values;
for a selected group of encoded weight values in the plurality of groups of encoded weight values:
obtaining a codebook index and a plurality of centroid indices from the selected group of encoded weight values;
identifying, from the obtained codebook index, one of a plurality of codebooks for the selected group of encoded weight values, each of the codebooks representing a discrete set of centroid values;
identifying, from the plurality of centroid indices using the identified codebook, a plurality of centroid values for the selected group of encoded weight values, the centroid values being derived from a plurality of centroid values from the discrete set of centroid values represented by the identified codebook; and
applying a scale factor for the selected group; and
outputting the set of output weight values corresponding to the set of encoded weight values, the set of output weight values comprising, for each of the plurality of groups of encoded weight values, weight values corresponding to the respective identified plurality of centroid values, scaled by the respective scale factor.

11. A method according to claim 10, wherein the method comprises:
for a first selected group of encoded weight values in the plurality of groups of encoded weight values:
obtaining a first codebook index and a first plurality of centroid indices from the first selected group of encoded weight values;
identifying, from the first codebook index, a first codebook;
identifying, from the first plurality of centroid indices using the first codebook, a first plurality of centroid values for the first selected group of encoded weight values; and
applying a first scale factor for the selected group; and
for a second selected group of encoded weight values in the plurality of groups of encoded weight values:
obtaining a second codebook index and a second plurality of centroid indices from the second selected group of encoded weight values;
identifying, from the second codebook index, a second codebook;
identifying, from the second plurality of centroid indices using the second codebook, a second plurality of centroid values for the second selected group of encoded weight values; and
applying a second scale factor for the selected group.

12. A method according to claim 10, wherein the method comprises applying a different scale factor and identifying a codebook from the same set of codebooks for each of the plurality of groups of input weight values.

13. A method according to claim 12, wherein the set of codebooks consists of between four and sixteen codebooks.

14. A method according to claim 10, wherein a number of input weight values in each group is equal to an integer multiple of a width of a Single Instruction Multiple Data (SIMD) vector.

15. A method according to claim 10, wherein a number of the plurality of codebooks is such that the plurality of codebooks fit into a local register file of a processor.

16. A method according to claim 10, wherein the centroid indices comprise 2-bit or 3-bit centroid indices.

17. A method according to claim 10, wherein the input weight values comprise LLM weight matrices.

18. A method according to claim 10, wherein the codebooks comprise codebooks having non-uniformly distributed centroids.

19. A method of generating a plurality of codebooks for quantizing sets of input weight values to produce sets of encoded weight values, the method comprising:
obtaining a set of input weight values, the set of output weight values including a plurality of weight values associated with one or more neural networks;
applying a group-wise structure to the set of input weight values;
applying scale factors to respective groups of the group-wise structure to generate scaled input weight values for each respective group; and
for each of a plurality of codebooks to be generated:
identifying a plurality of similar distributions of the scaled input weight values in different groups in the respective groups of the group-wise structure;
clustering scaled input weight values from the plurality of similar distributions of different groups in respective discrete clusters to identify a predetermined number of centroid values from the clustered scaled input weight values; and
generating a codebook from the identified centroid values.

20. A processing element adapted to decompress a set of output weight values from a set of encoded weight values, the processing element adapted to:
obtain a set of encoded weight values corresponding to a set of output weight values, the set of output weight values including a plurality of weight values associated with a neural network;
select a plurality of groups of encoded weight values corresponding to a plurality of groups of output weight values from the set of output weight values;
for a selected group of encoded weight values in the plurality of groups of encoded weight values:
obtain a codebook index and a plurality of centroid indices from the selected group of encoded weight values;
identify, from the obtained codebook index, one of a plurality of codebooks for the selected group of encoded weight values, each of the codebooks representing a discrete set of centroid values;
identify, from the plurality of centroid indices using the identified codebook, a plurality of centroid values for the selected group of encoded weight values, the centroid values being derived from a plurality of centroid values from the discrete set of centroid values represented by the identified codebook; and
apply a scale factor for the selected group; and
output the set of output weight values corresponding to the set of encoded weight values, the set of output weight values comprising, for each of the plurality of groups of encoded weight values, weight values corresponding to the respective identified plurality of centroid values, scaled by the respective scale factor.
